(19) United States
(12) Patent Application Publication
(10) Pub. No.: US 2014/0046527 A1
(43) Pub. Date: Feb. 13, 2014

(54) DRIVE CONTROL APPARATUS FOR HYBRID VEHICLE

(71) Applicants: Yoshiki Ito, Hamamatsu-shi (JP); Masaaki Tagawa, Hamamatsu-shi (JP); Masakazu Saito, Hamamatsu-shi (JP); Hitoshi Ohkuma, Hamamatsu-shi (JP)

(72) Inventors: Yoshiki Ito, Hamamatsu-shi (JP); Masaaki Tagawa, Hamamatsu-shi (JP); Masakazu Saito, Hamamatsu-shi (JP); Hitoshi Ohkuma, Hamamatsu-shi (JP)

(21) Appl. No.: 13/981,801

(22) PCT Filed: Jan. 31, 2011
(86) PCT No.: PCT/JP2011/051908

§ 371 Date: Oct. 15, 2013

(51) Int. Cl. B60W 20/00; B60W 10/08; B60W 10/06

(52) U.S. Cl. CPC B60W 20/108; B60W 10/06; B60W 10/08; Y10S 903/93
USPC 701/22; 180/65.265; 903/930

(57) ABSTRACT

An object of the present invention is to improve drivability and traveling feeling without influence of torque variation of an internal combustion engine on a drive torque while ensuring the compatibility with a driving force and charge/discharge by control.

A drive control apparatus for a hybrid vehicle includes first and second motor-generator, a differential gear mechanism, an accelerator position detecting unit, a vehicular speed detecting unit, a battery state-of-charge detecting unit, a target drive power setting unit, a target charging/discharging power setting unit, a target engine power calculation unit, a target engine operating point setting unit, a motor torque command value operation unit. The drive control apparatus performs a feedback correction on calculated torque command values for a plurality of motor-generators. The motor torque command value operation unit calculates the torque correction values of the plurality of motor-generators based on a deviation between an actual engine rotation speed and a target engine rotation speed during the feedback correction, and sets a ratio between the torque correction values of the plurality of motor-generators to a predetermined ratio based on a lever ratio of the drive control apparatus.

### TECHNICAL FIELD

The present invention relates to a control apparatus for a hybrid vehicle that includes a plurality of power sources and combines powers of the power sources by a differential gear mechanism to input from and output to the combined power to a drive shaft, especially to a drive control apparatus for a hybrid vehicle that controls an operating point of an internal combustion engine and a motor torque.

### BACKGROUND ART

Conventionally, systems for a hybrid car with an electric machine and an internal combustion engine include systems disclosed in, for example, Japanese Patent No. 3050125, Japanese Patent No. 3050138, Japanese Patent No. 3050141, Japanese Patent No. 3097572 in addition to a series system and a parallel system. These disclosed systems employs a system that uses one planetary gear (a differential gear mechanism with three rotational elements) and two electric machines to split a power of an internal combustion engine into respective powers for a generator and a drive shaft, and uses an electric power generated by the generator to drive the electric machine disposed at the drive shaft, so as to perform torque conversion of the power of the internal combustion engine.

This type is referred to as a “three-shaft type”.

In this conventional technique, the operating point of the internal combustion engine can be set to a point including stop. This improves fuel efficiency.

However, not as much as the series system, in order to obtain a sufficient torque of the drive shaft, an electric machine with a comparatively large torque is necessary and amounts of delivery and receipt of electric power is increased between the generator and the electric machine in a LOW gear range. This increases electrical loss. Therefore, there is still room for improvement.

Methods for solving this point are disclosed in Japanese Patent No. 3578451, Japanese Unexamined Patent Application Publication No. 2004-15982, and disclosed in Japanese Unexamined Patent Application Publication No. 2002-281607 by this applicant.

In the method of Japanese Unexamined Patent Application Publication No. 2002-281607, respective rotational elements of a differential gear mechanism with four rotational elements are coupled to an output shaft of an internal combustion engine, a first motor-generator (hereinafter also referred to as “MG1”), a second motor-generator (hereinafter also referred to as “MG2”), and a drive shaft coupled to a drive wheel. This combines a power of the internal combustion engine with powers of MG1 and MG2 to output the combined power to the drive shaft.

On the collinear diagram, the output shaft of the internal combustion engine and the drive shaft are disposed as the rotational elements at the inner side. MG1 (at the internal combustion engine side) and MG2 (at the drive shaft side) are disposed as the rotational elements at the outer side on the collinear diagram. This reduces proportions of powers of MG1 and MG2 among the power transmitted from the internal combustion engine to the drive shaft. This reduces sizes of MG1 and MG2, and improves transmission efficiency as a drive apparatus.

This type is referred to as a “four-shaft type”.

The proposed method of Japanese Patent No. 3578451 is similar to the above-described method. Additionally, the method includes a fifth rotational element and a brake that stops rotation of this rotational element.

In the conventional technique, as disclosed in Japanese Patent No. 3050125, the driving force required for the vehicle and an electric power required for charging a storage battery are added to calculate a power to be output by the internal combustion engine. A point with the highest possible efficiency is calculated among combinations of a torque generating the power and a rotation speed to set a target engine operating point.

Subsequently, MG1 is controlled such that an operating point of the internal combustion engine becomes the target operating point. Thus, an engine rotation speed is controlled.
Patent Document 1: Japanese Unexamined Patent Application Publication No. 2008-12992

### DISCLOSURE OF THE INVENTION

### Problems to be Solved by the Invention

Incidentally, in the case where the conventional drive control apparatus for the hybrid vehicle is the “three-shaft type”, the torque of MG2 does not affect torque balance. Accordingly, the torque of MG1 is controlled by feedback such that the engine rotation speed approaches the target value. This torque of MG1 is used to calculate a torque to be output to the drive shaft from the internal combustion engine and MG1. The torque of MG2 is controlled to have a value where a value of the calculated torque is subtracted from the target driving force. This outputs the target driving force from the drive shaft even in the case where the engine torque varies.

However, in case of the “four-shaft type”, the drive shaft and MG2 have different shafts. The torque of MG2 affects the torque balance, thus affecting control of the engine rotation speed. Therefore, a problem arises in that the control method for the “three-shaft type” is not usable.

In Japanese Unexamined Patent Application Publication No. 2004-15982 where the “four-shaft type” is described, the disclosed method uses a torque balance equation to calculate respective torques of MG1 and MG2 while running without charging and discharging the battery. This method performs a feedback control of the rotation speed to control the engine rotation speed and the driving force.

However, the case where the battery is charged and discharged or the case where the engine torque varies is not mentioned.

Further, a technique disclosed in Patent Document 1 is a technique for controlling an internal combustion engine in a hybrid system that includes an internal combustion engine and a plurality of motor-generators. This technique sets a high engine rotation speed regarding an operating point of the internal combustion engine.

At this time, a control for the plurality of motor-generators is unknown in Patent Document 1. Furthermore, in the case where the battery is charged and discharged, a control for the plurality of motor-generators is unknown.

During the control, it is necessary that the internal combustion engine and the plurality of motor-generators are mechanically coupled in operation to associate the plurality of motor-generators with one another while maintaining the operating point of the internal combustion engine at the target value, so as to maintain torque balance. Additionally, in the case where the battery is charged and discharged, it is also necessary to balance input and output of the electric power.

It is necessary to ensure the compatibility with these balances by control.

During a control where the plurality of motor-generators are associated with one another to maintain torque balance, even in the case where a feedback control is performed, a problem arises in that variation in torque of the internal combustion engine affects the drive torque depending on the process of the control.

It is an object of the present invention to improve drivability and traveling feeling as a control for a plurality of motor-generators in the case where a battery is charged and discharged in a hybrid system with an internal combustion engine and the plurality of motor-generators. In the case where a control is performed to ensure the compatibility with a target driving force and target charging/discharging while considering an operating point of the internal combustion engine, the present invention optimizes variation in torque of the internal combustion engine not to affect the drive torque.

### Solutions to the Problems

In order to eliminate the above inconvenience, the present invention has the following configuration. A drive control apparatus for a hybrid vehicle includes: an internal combustion engine with an output shaft; a drive shaft coupled to a drive wheel; first and second motor-generators; a differential gear mechanism that includes respective four rotational elements coupled to the plurality of motor-generators, the drive shaft, and the internal combustion engine; an accelerator position detecting unit configured to detect an accelerator position; a vehicular speed detecting unit configured to detect a vehicular speed; a battery state-of-charge detecting unit configured to detect a state of charge of battery; a target drive power setting unit configured to set a target drive power based on an accelerator position detected by the accelerator position detecting unit and a vehicular speed detected by the vehicular speed detecting unit; a target charging/discharging power setting unit configured to set a target charging/discharging power based on at least a state of charge of battery detected by the battery state-of-charge detecting unit; a target engine power calculation unit configured to calculate a target engine power using the target drive power setting unit and the target charging/discharging power setting unit; a target engine operating point setting unit configured to set a target engine operating point based on the target engine power and an overall efficiency of a system; and a motor torque command value operation unit configured to set respective torque command values of the plurality of motor-generators. The motor torque command value operation unit is configured to: calculate respective torque command values of the plurality of motor-generators using a torque balance equation and a power balance equation, the torque balance equation including a target engine torque obtained from the target engine operating point, the power balance equation including the target charging/discharging power; and allow respective feedback corrections of the torque command values for the plurality of motor-generators such that an actual engine rotation speed converges to a target engine rotation speed obtained from the target engine operating point in the drive control apparatus for the hybrid vehicle. The motor torque command value operation unit is configured to: calculate a torque correction value of the first motor-generator and a torque correction value of the second motor-generator among the plurality of motor-generators based on a deviation between the actual engine rotation speed and the target engine rotation speed when the feedback correction is performed; and set a ratio between the torque correction value of the first motor-generator and the torque correction value of the second motor-generator to a predetermined ratio based on a lever ratio of the drive control apparatus for the hybrid vehicle.

### Effects of the Invention

As described above, with the present invention, a drive control apparatus for a hybrid vehicle includes: an internal combustion engine with an output shaft; a drive shaft coupled to a drive wheel; first and second motor-generators; a differential gear mechanism that includes respective four rotational elements coupled to the plurality of motor-generators, the drive shaft, and the internal combustion engine; an accelerator position detecting unit configured to detect an accelerator position; a vehicular speed detecting unit configured to detect a vehicular speed; a battery state-of-charge detecting unit configured to detect a state of charge of battery; a target drive power setting unit configured to set a target drive power based on an accelerator position detected by the accelerator position detecting unit and a vehicular speed detected by the vehicular speed detecting unit; a target charging/discharging power setting unit configured to set a target charging/discharging power based on at least a state of charge of battery detected by the battery state-of-charge detecting unit; a target engine power calculation unit configured to calculate a target engine power using the target drive power setting unit and the target charging/discharging power setting unit; a target engine operating point setting unit configured to set a target engine operating point based on the target engine power and an overall efficiency of a system; and a motor torque command value operation unit configured to set respective torque command values of the plurality of motor-generators. The motor torque command value operation unit is configured to: calculate respective torque command values of the plurality of motor-generators using a torque balance equation and a power balance equation, the torque balance equation including a target engine torque obtained from the target engine operating point, the power balance equation including the target charging/discharging power; and allow respective feedback corrections of the torque command values for the plurality of motor-generators such that an actual engine rotation speed converges to a target engine rotation speed obtained from the target engine operating point in the drive control apparatus for the hybrid vehicle. The motor torque command value operation unit is configured to: calculate a torque correction value of the first motor-generator and a torque correction value of the second motor-generator among the plurality of motor-generators based on a deviation between the actual engine rotation speed and the target engine rotation speed when the feedback correction is performed; and set a ratio between the torque correction value of the first motor-generator and the torque correction value of the second motor-generator to a predetermined ratio based on a lever ratio of the drive control apparatus for the hybrid vehicle. Therefore, the torque balance equation focused on variation in torque where the drive shaft is a supporting point is used to cancel the variation in torque of the internal combustion engine. This prevents the variation in torque of the internal combustion engine from affecting the torque of the drive shaft even if the variation occurs.

This allows respective controls of the plurality of motor-generators in the case where the battery is charged and discharged.

Additionally, this ensures the compatibility with a target driving force and target charging/discharging considering the operating point of the internal combustion engine.

Furthermore, the respective torque command values of the plurality of motor-generators are specifically corrected. This allows the engine rotation speed to promptly converge to the target value.

This allows the engine operating point to coincide with the target operating point to provide an appropriate driving state.

### BRIEF DESCRIPTION OF THE DRAWINGS

FIG. 1 is a system block diagram of a drive control apparatus for a hybrid vehicle.

FIG. 2 is a control block diagram for operation of a target operating point.

FIG. 3 is a control block diagram for operation of a torque command value.

FIG. 4 is a flowchart for a control for the operation of the target operating point of the engine.

FIG. 5 is a flowchart for the operation of the torque command value.

FIG. 6 is a map for searching target driving force defined by a target driving force and a vehicle speed.

FIG. 7 is a table for searching target charging/discharging power defined by a target charging/discharging power and a battery state-of-charge detecting unit.

FIG. 8 is a map for searching target engine operating point defined by s an engine torque and an engine rotation speed.

FIG. 9 is a collinear diagram in the case where a vehicle speed varies at the same engine operating point.

FIG. 10 is a graph illustrating a best line for engine efficiency defined by the engine torque and the engine rotation speed and a best line for overall efficiency.

FIG. 11 is a graph illustrating respective efficiencies on an equal power line defined by the efficiency and the engine rotation speed.

FIG. 12 is a collinear diagram illustrating respective points (D, E, and F) on the equal power line.

FIG. 13 is a collinear diagram illustrating a state of a LOW gear ratio.

FIG. 14 is a collinear diagram illustrating a state of an intermediate gear ratio.

FIG. 15 is a collinear diagram illustrating a state of a HIGH gear ratio.

FIG. 16 is a collinear diagram illustrating a state generating power circulation.

FIG. 17 is a collinear diagram of a basic torque and a feedback torque.

FIG. 18 is a collinear diagram in case of feedback based only on MG1.

### DESCRIPTION OF PREFERRED EMBODIMENTS

Hereinafter, a detailed description will be given of an embodiment of the present invention based on the drawings.

### Embodiment

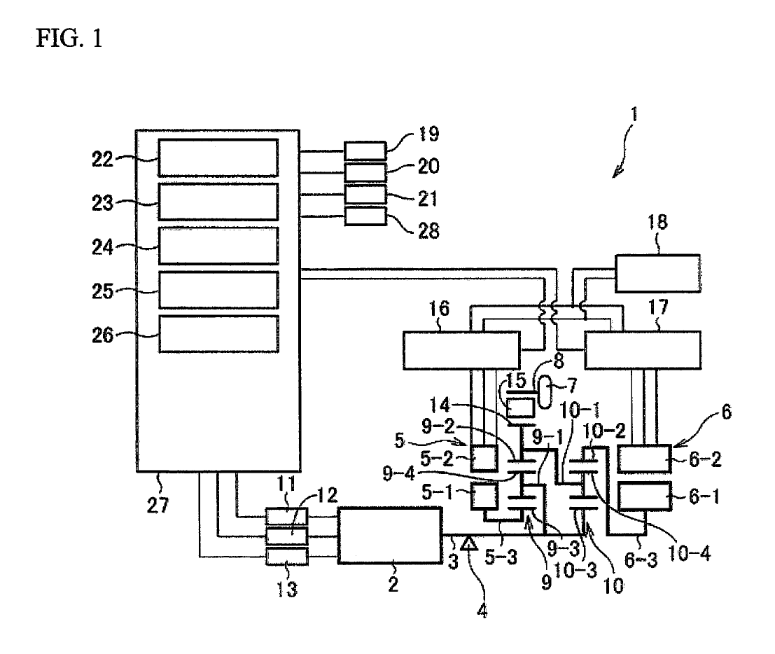

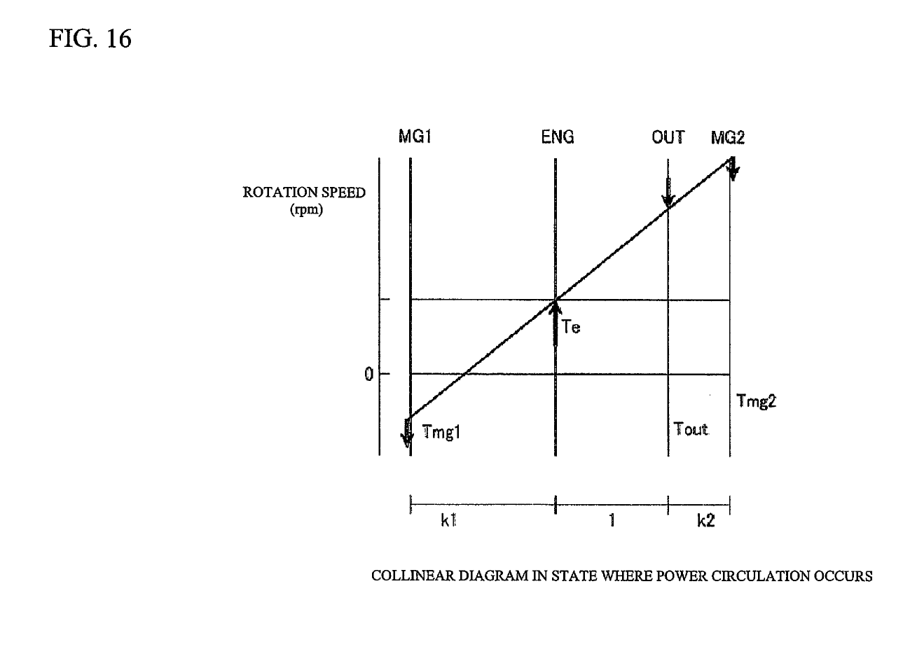

FIG. 1 to FIG. 18 illustrate an embodiment of the present invention.

In FIG. 1, reference numeral 1 denotes a drive control apparatus for a hybrid vehicle (not shown), that is, a four-shaft type power input/output unit to which the present invention is applied.

The drive control apparatus 1 for the hybrid vehicle includes, as illustrated in FIG. 1, an internal combustion engine (also described as “E/G” or “ENG”) 2, an output shaft 3 of the internal combustion engine 2, a first motor-generator (also referred to as “MG1” or “first electric motor”) 5 and a second motor-generator (also referred to as “MG2” or “second electric motor”) 6, a drive shaft 8, and a first planetary gear (also referred to as “PG1”) 9 and a second planetary gear (also referred to as “PG2”) 10. The internal combustion engine 2 generates a driving force by burning fuel as a drive system for drivingly controlling a vehicle using an output from an electric machine and itself. The first motor-generator 5 and the second motor-generator 6 are coupled via a one-way clutch 4, and generate a driving force by electricity and generating electric energy by driving. The drive shaft 8 is coupled to a drive wheel 7 of the hybrid vehicle. The first planetary gear 9 and the second planetary gear 10 are each coupled to the output shaft 3, the first motor-generator 5, the second motor-generator 6, and the drive shaft 8.

The internal combustion engine 2 includes an air-amount adjusting unit 11 such as a throttle valve, a fuel supply unit 12 such as a fuel injection valve, and an ignition unit 13 such as an ignition device. The air-amount adjusting unit 11 adjusts an amount of air to be sucked corresponding to an accelerator position (a depression amount of an accelerator pedal). The fuel supply unit 12 supplies fuel corresponding to the amount of air to be sucked. The ignition unit 13 ignites fuel.

In the internal combustion engine 2, a burning state of fuel is controlled by the air-amount adjusting unit 11, the fuel supply unit 12, and the ignition unit 13 to generate a driving force.

At this time, the first planetary gear 9 includes, as illustrated in FIG. 1, a first planetary carrier (also referred to as “C1”) 9-1, a first ring gear 9-2, a first sun gear 9-3, and a first pinion gear 9-4. The first planetary gear 9 also includes an output gear 14 and an output transmission mechanism (also referred to as “gear mechanism” or “differential gear mechanism” described below) 15. The output gear 14 communicates with the drive shaft 8 of the drive wheel 7. The output transmission mechanism 15 includes, for example, gears and chains to couple this output gear 14 to the drive shaft 8.

The second planetary gear 10 includes, as illustrated in FIG. 1, a second planetary carrier (also referred to as “C2”) 10-1, a second ring gear 10-2, a second sun gear 10-3, and a second pinion gear 10-4.

As illustrated in FIG. 1, the first planetary carrier 9-1 of the first planetary gear 9 and the second sun gear 10-3 of the second planetary gear 10 are joined together, and then coupled to the output shaft 3 of the internal combustion engine 2.

As illustrated in FIG. 1, the first ring gear 9-2 of the first planetary gear 9 and the second planetary carrier 10-1 of the second planetary gear 10 are joined together, and then coupled to the output gear 14 as an output member that communicates with the drive shaft 8.

The first motor-generator 5 includes a first motor rotor 5-1, a first motor stator 5-2, and a first motor rotor shaft 5-3. The second motor-generator 6 includes a second motor rotor 6-1, a second motor stator 6-2, and a second motor rotor shaft 6-3.

As illustrated in FIG. 1, the first sun gear 9-3 of the first planetary gear 9 is coupled to the first motor rotor 5-1 of the first motor-generator 5. The second ring gear 10-2 of the second planetary gear 10 is coupled to the second motor rotor 6-1 of the second motor-generator 6.

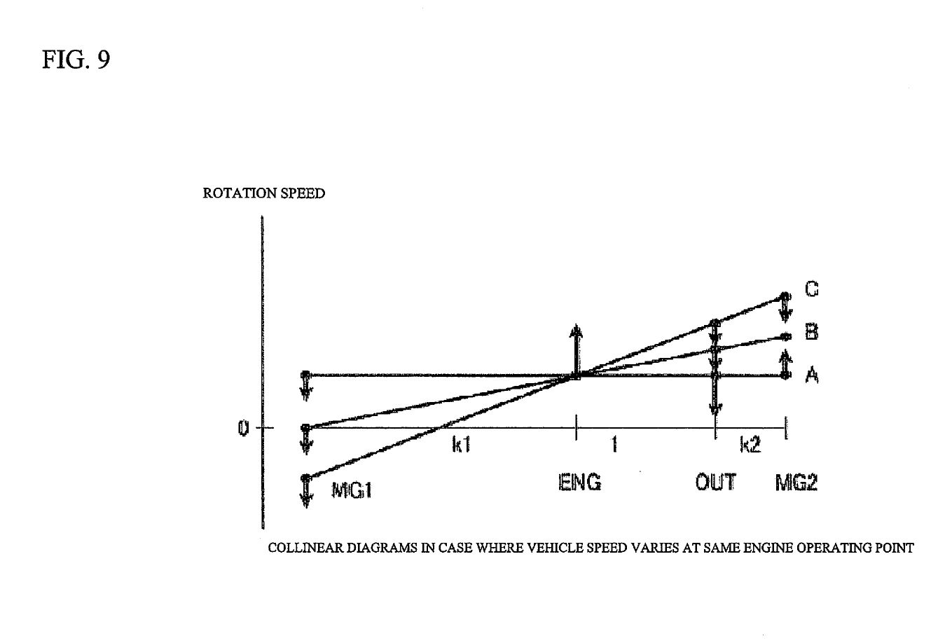

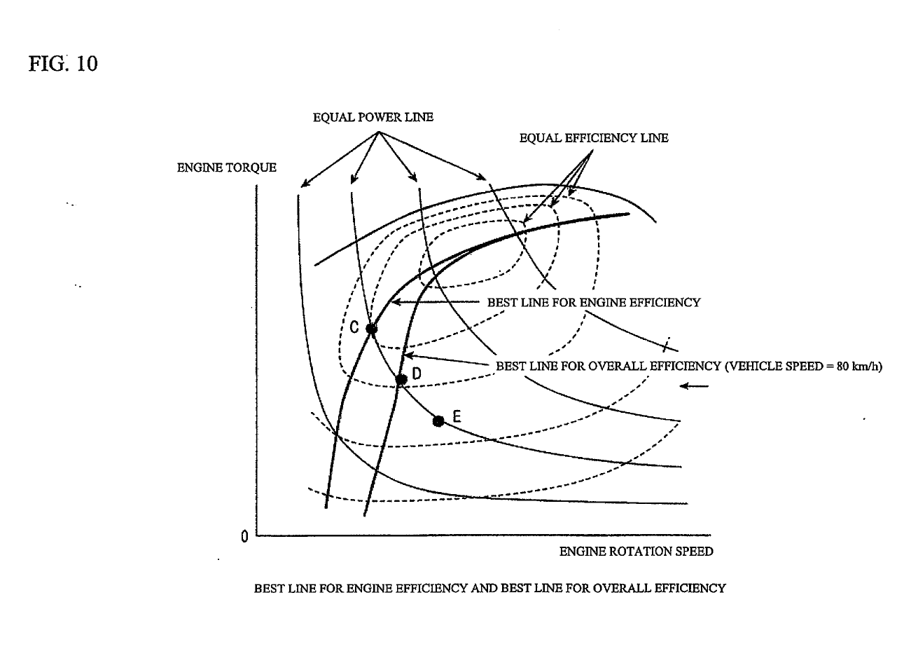

That is, the hybrid vehicle includes the differential gear mechanism 15 that is a gear mechanism for coupling four elements constituted by the internal combustion engine 2, the first motor-generator 5, the second motor-generator 6, and the output gear 14 with one another in the order corresponding to the first motor-generator 5, the output gear 14, and the second motor-generator 6 on collinear diagrams (see FIG. 9 and FIG. 10).

Therefore, power is transmitted or received among the internal combustion engine 2, the first motor-generator 5, the second motor-generator 6, and the drive shaft 8.

Further, the first motor stator 5-2 of the first motor-generator 5 is coupled to a first inverter 16. The second motor stator 6-2 of the second motor-generator 6 is coupled to a second inverter 17.

The first and second inverters 16 and 17 respectively controls the first and second motor-generators 5 and 6.

The respective power supply terminals of the first and second inverters 16 and 17 are coupled to a battery 18 as an electric storage device.

The drive control apparatus 1 for the hybrid vehicle drivingly controls a vehicle using respective outputs from the internal combustion engine 2, the first and second motor-generators 5 and 6.

The drive control apparatus 1 for the hybrid vehicle includes the internal combustion engine 2 with the output shaft 3, the drive shaft 8 coupled to the drive wheel 7, the first and second motor-generators 5 and 6, the differential gear mechanism 15. The differential gear mechanism 15 includes the respective four rotational elements coupled to the first and second motor-generators 5 and 6 as a plurality of motor-generators, the drive shaft 8, and the internal combustion engine 2. The drive control apparatus 1 for the hybrid vehicle also includes an accelerator position detecting unit 19 to detect an accelerator position, a vehicular speed detecting unit 20 to detect a vehicular speed, a battery state-of-charge detecting unit 21 to detect a state of charge of the battery 18, a target drive power setting unit 22, a target charging/discharging power setting unit 23, a target engine power calculation unit 24, a target engine operating point setting unit 25, and a motor torque command value operation unit 26. The target drive power setting unit 22 sets a target drive power based on the accelerator position detected by the accelerator position detecting unit 19 and the vehicular speed detected by the vehicular speed detecting unit 20. The target charging/discharging power setting unit 23 sets a target charging/discharging power based on at least the state of charge of the battery 18 detected by the battery state-of-charge detecting unit 21. The target engine power calculation unit 24 calculates a target engine power using the target drive power setting unit 22 and the target charging/discharging power setting unit 23. The target engine operating point setting unit 25 sets a target engine operating point based on the target engine power and overall efficiency of the system. The motor torque command value operation unit 26 sets respective torque command values Tmg1 and Tmg2 of the first and second motor-generators 5 and 6 as the plurality of motor-generators.

At this time, the air-amount adjusting unit 11, the fuel supply unit 12, and the ignition unit 13 of the internal combustion engine 2, the first motor stator 5-2 of the first motor-generator 5, the second motor stator 6-2 of the second motor-generator 6 are coupled to a drive controller 27 as a control system of the drive control apparatus 1 for the hybrid vehicle.

The drive controller 27 of the drive control apparatus 1 for the hybrid vehicle includes, as illustrated in FIG. 1, the accelerator position detecting unit 19, the vehicular speed detecting unit 20, the battery state-of-charge detecting unit 21, and the engine rotation speed detecting unit 28.

The accelerator position detecting unit 19 detects an accelerator position as a depression amount of the accelerator pedal.

The vehicular speed detecting unit 20 detects a vehicular speed (vehicle speed) of the hybrid vehicle.

The battery state-of-charge detecting unit 21 detects a state of charge SOC of the battery 18.

The drive controller 27 for operation of a target operating point includes, as illustrated in FIG. 1, the target drive power setting unit 22, the target charging/discharging power setting unit 23, the target engine power calculation unit 24, the target engine operating point setting unit 25, and the motor torque command value operation unit 26.

The target drive power setting unit 22 has a function for setting the target drive power to drive the hybrid vehicle based on the accelerator position detected by the accelerator position detecting unit 19 and the vehicular speed detected by the vehicular speed detecting unit 20.

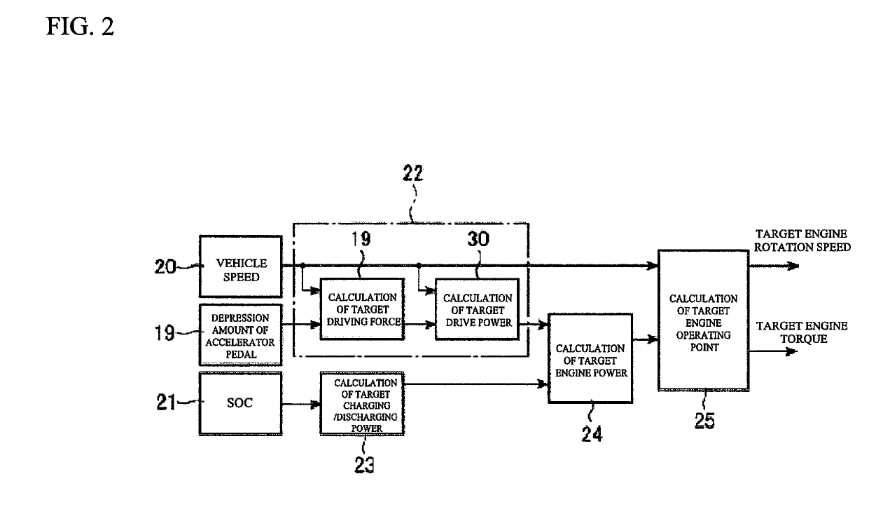

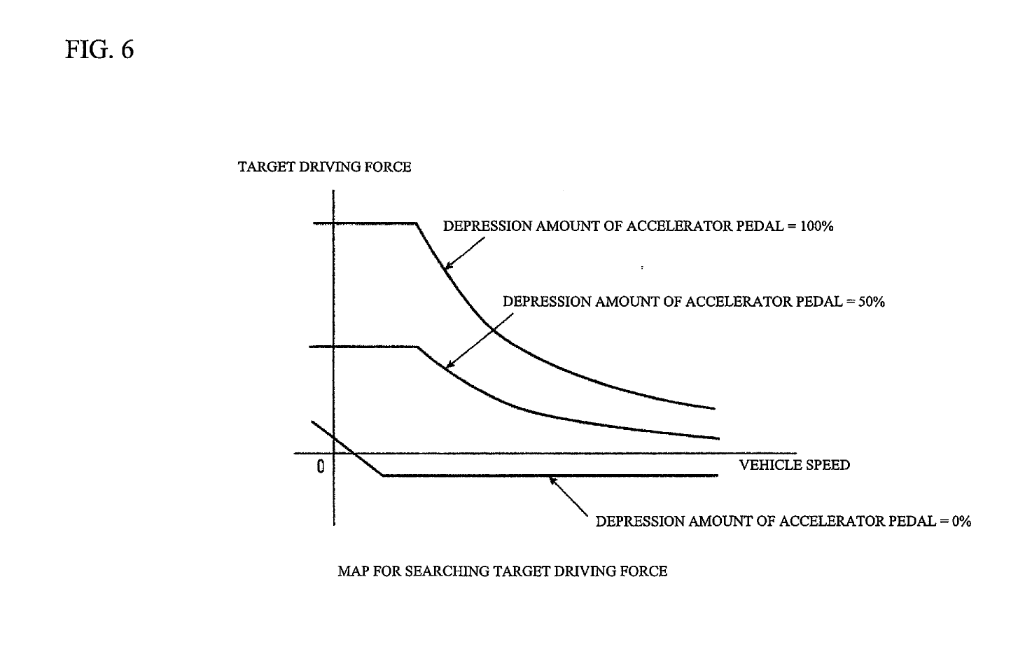

That is, the target drive power setting unit 22 includes, as illustrated in FIG. 2, a target driving force calculator 29 and a target drive power calculator 30. The target driving force calculator 29 sets a target driving force based on a search map for target driving force illustrated in FIG. 6 corresponding to the accelerator position detected by the accelerator position detecting unit 19 and the vehicular speed detected by the vehicular speed detecting unit 20.

At this time, in a high vehicle speed range in the case where “the accelerator position=0”, the target driving force is set to a negative value to obtain a driving force in a decelerating direction equivalent to engine brake. In a range at low vehicle speed, the target driving force is set to a positive value to allow creep running.

The target drive power calculator 30 multiplies the target driving force, which is set by the target driving force calculator 29, by the vehicular speed, which is detected by the vehicular speed detecting unit 20, to calculate a target drive power required for driving a vehicle using the target driving force.

The target charging/discharging power setting unit 23 sets a target charging/discharging power based on at least the state of charge SOC of the battery 18 detected by the battery state-of-charge detecting unit 21.

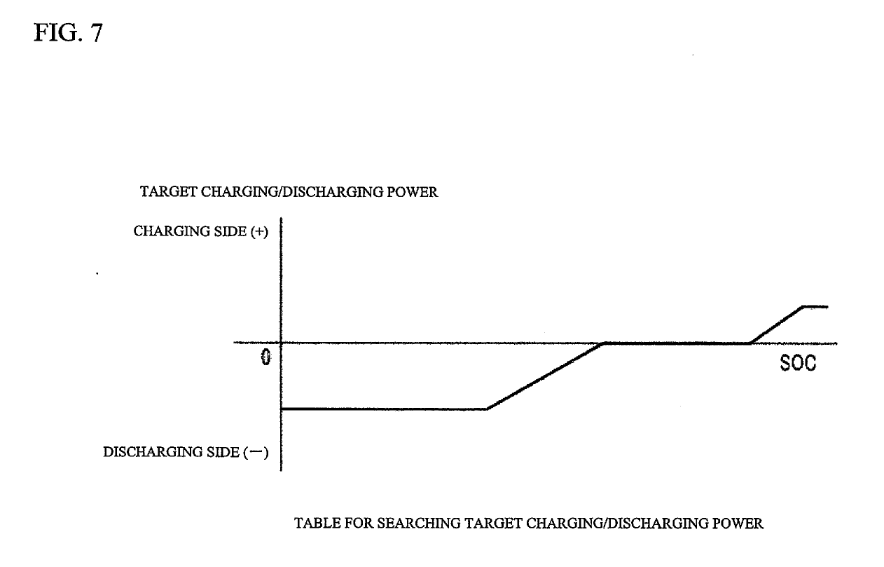

In this embodiment, the target charging/discharging power is set by searching a map for searching target charging/discharging power illustrated in FIG. 7 corresponding to the state of charge SOC of the battery.

The target engine power calculation unit 24 calculates the target engine power based on the target drive power set by the target drive power setting unit 22 and the target charging/discharging power set by the target charging/discharging power setting unit 23.

In this embodiment, the target charging/discharging power is subtracted from the target drive power to obtain the target engine power.

The target engine operating point setting unit 25 sets the target engine operating point based on the target engine power and the overall efficiency of the system.

The motor torque command value operation unit 26 sets respective torque command values Tmg1 and Tmg2 of the first and second motor-generators 5 and 6 as the plurality of motor-generators.

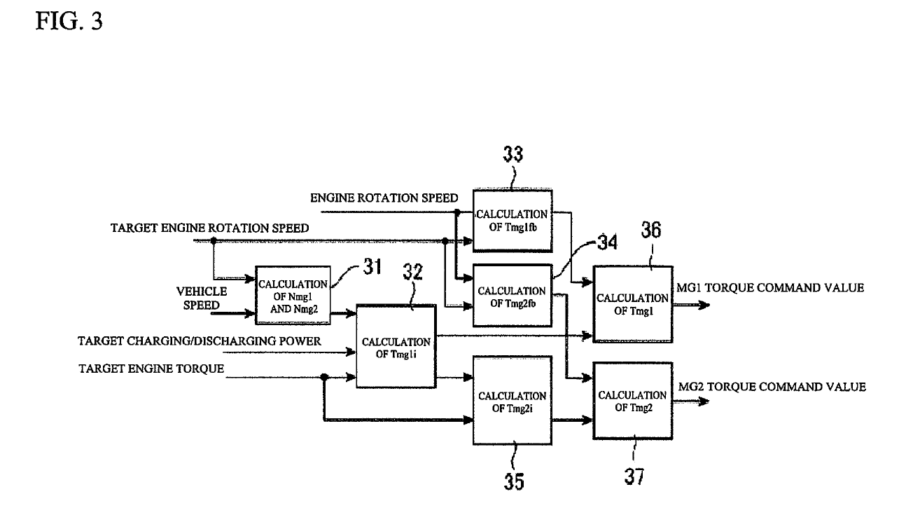

The drive controller 27 for calculating the torque command value includes first to seventh calculators 31 to 37 as illustrated in FIG. 3.

The first calculator 31 uses the target engine rotation speed (see FIG. 2) obtained by operation of the target engine operating point setting unit 25 and the vehicular speed (vehicle speed) from the vehicular speed detecting unit 20 to calculate an MG1 rotation speed Nmg1 of the first motor-generator 5 and an MG2 rotation speed Nmg2 of the second motor-generator 6 in the case where the engine rotation speed becomes a target engine rotation speed Net.

The second calculator 32 uses the MG1 rotation speed Nmg1 and the MG2 rotation speed Nmg2 calculated by the first calculator 31 and a target engine torque (see FIG. 2) obtained by operation of the target engine operating point setting unit 25 to calculate a basic torque Tmg1i of the first motor-generator 5.

The third calculator 33 uses the engine rotation speed from the engine rotation speed detecting unit 28 and the target engine torque (see FIG. 2) obtained by operation of the target engine operating point setting unit 25 to calculate a feedback correction torque Tmg1fb of the first motor-generator 5.

The fourth calculator 34 uses the engine rotation speed from the engine rotation speed detecting unit 28 and the target engine torque (see FIG. 2) obtained by operation of the target engine operating point setting unit 25 to calculate the feedback correction torque Tmg2fb of the second motor-generator 6.

The fifth calculator 35 uses the basic torque Tmg1i of the first motor-generator 5 from the second calculator 32 and the target engine torque (see FIG. 2) obtained by operation of the target engine operating point setting unit 25 to calculate a basic torque Tmg2i of the second motor-generator 6.

The sixth calculator 36 uses the basic torque Tmg1i of the first motor-generator 5 from the second calculator 32 and the feedback correction torque Tmg1fb of the first motor-generator 5 from the third calculator 33 to calculate the torque command value Tmg1 of the first motor-generator 5.

The seventh calculator 37 uses the feedback correction torque Tmg2fb of the second motor-generator 6 from the fourth calculator 34 and the basic torque Tmg2i of the second motor-generator 6 from the fifth calculator 35 to calculate the torque command value Tmg2 of the second motor-generator 6.

In the drive control apparatus 1 for the hybrid vehicle, the motor torque command value operation unit 26 uses a torque balance equation that includes the target engine torque obtained from the target engine operating point and a power balance equation that includes the target charging/discharging power, to calculate respective torque command values Tmg1 and Tmg2 of the first and second motor-generators 5 and 6 as the plurality of motor-generators. The motor torque command value operation unit 26 performs respective feedback corrections of the torque command values Tmg1 and Tmg2 of the first and second motor-generators 5 and 6 as the plurality of motor-generators such that the actual engine rotation speed converges to the target engine rotation speed obtained from the target engine operating point.

Additionally, the motor torque command value operation unit 26 is configured to calculate a torque correction value (also referred to as “feedback correction torque Tmg1fb”) of the first motor-generator 5 and a torque correction value (also referred to as “feedback correction torque Tmg2fb”) of the second motor-generator 6 as the plurality of motor-generators based on a deviation between the actual engine rotation speed and the target engine rotation speed when performing these feedback corrections. The motor torque command value operation unit 26 is also configured to set a ratio of the feedback correction torque Tmg1fb as the torque correction value of the first motor-generator 5 to the feedback correction torque Tmg2fb as the torque correction value of the second motor-generator 6 as a predetermined ratio based on a lever ratio of the drive control apparatus 1 for the hybrid vehicle.

Therefore, the torque balance equation focused on variation in torque where the drive shaft 8 is a supporting point is used to cancel the variation in torque of the internal combustion engine 2. This prevents the variation in torque of the internal combustion engine 2 from affecting the torque of the drive shaft even if the variation occurs.

This allows respective controls of the first and second motor-generators 5 and 6 as the plurality of motor-generators in the case where the battery 18 is charged and discharged.

Additionally, this ensures the compatibility with a target driving force and target charging/discharging considering the operating point of the internal combustion engine 2.

Furthermore, the respective torque command values Tmg1 and Tmg2 of the first and second motor-generators 5 and 6 as the plurality of motor-generators are specifically corrected. This allows the engine rotation speed to promptly converge to the target value.

Therefore, this allows the engine operating point to coincide with the target operating point to provide an appropriate driving state.

The differential gear mechanism 15 includes the four rotational elements arranged in the order corresponding to the rotational element coupled to the first motor-generator 5, the rotational element coupled to the internal combustion engine 2, the rotational element coupled to the drive shaft 8, and the rotational element coupled to the second motor-generator 6 in collinear diagram. Respective mutual lever ratios among these elements are set as k1:1:k2 in the same order. The feedback correction torque Tmg1fb as the torque correction value of the first motor-generator 5 and the feedback correction torque Tmg2fb as the torque correction value of the second motor-generator 6 are set to maintain a relationship where a value of the feedback correction torque Tmg1fb, which is the first motor-generator 5, multiplied by k1 is equal to a value of the feedback correction torque Tmg2fb, which is the torque correction value of the second motor-generator 6, multiplied by 1+k2.

Therefore, in the case where the differential gear mechanism 15 that includes similar four rotational elements with different lever ratios is constituted, this configuration is preferably used.

The differential gear mechanism 15 includes the respective four rotational elements arranged in the order corresponding to the rotational element coupled to the first motor-generator 5, the rotational element coupled to the internal combustion engine 2, the rotational element coupled to the drive shaft 8, and the rotational element coupled to the second motor-generator 6 in the collinear diagram. Respective mutual lever ratios among these elements are set as k1:1:k2 in the same order. A feedback gain is set such that the feedback correction torque Tmg1fb as the torque correction value of the first motor-generator 5 and the feedback correction torque Tmg2fb as the torque correction value of the second motor-generator 6 have a relationship where the value of the feedback correction torque Tmg1fb, which is the torque correction value of the first motor-generator 5, multiplied by k1 is equal to a value of the feedback correction torque Tmg2fb, which is the torque correction value of the second motor-generator 6, multiplied by 1+k2.

Therefore, in the case where the differential gear mechanism 15 that includes similar four rotational elements with different lever ratios is constituted, this configuration is preferably used.

Preliminarily setting the gain significantly reduces the load of operation in the feedback control of the control apparatus.

Next, a description will be given of operation.

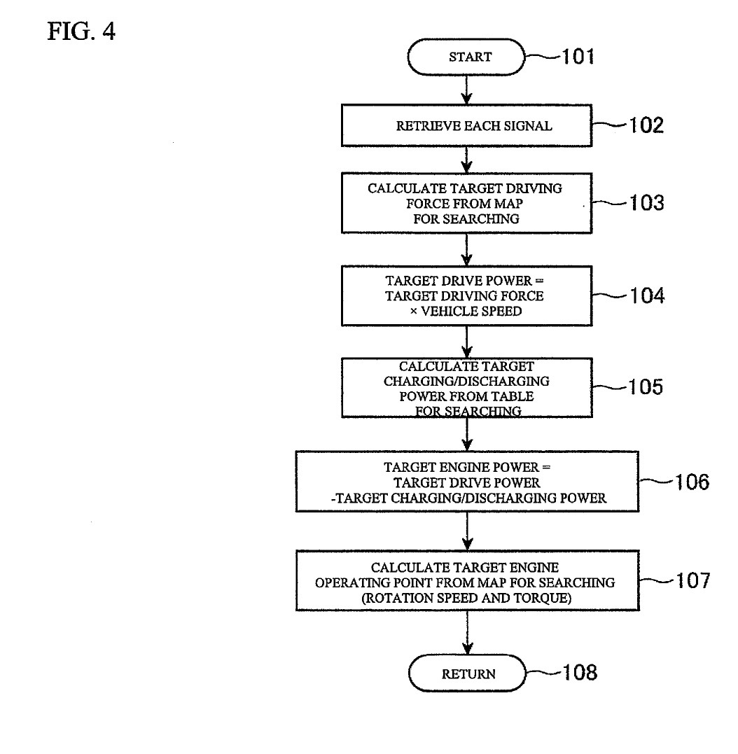

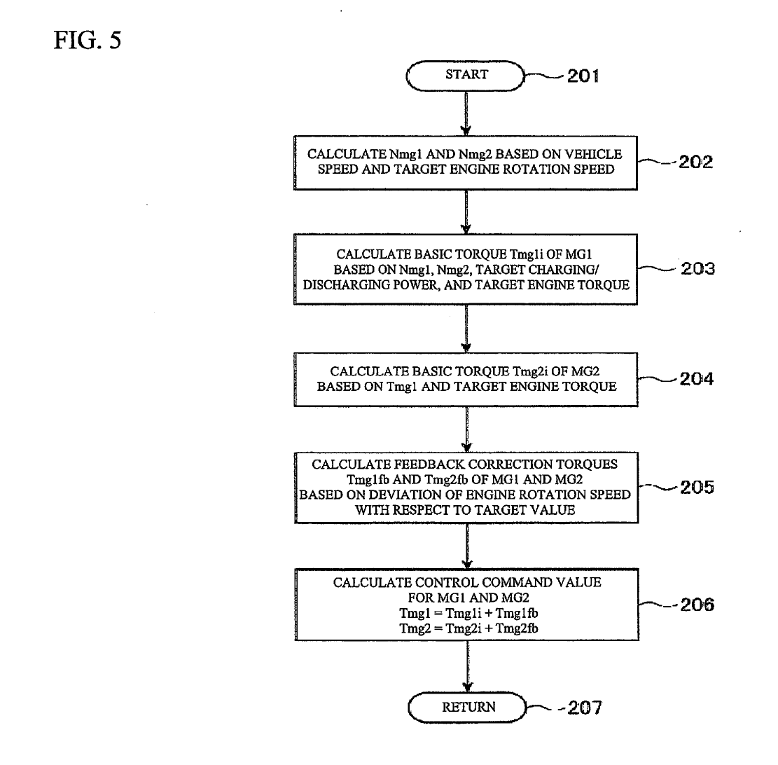

In a flowchart for control of calculating a target operating point of the engine in FIG. 4, the target engine operating point (the target engine rotation speed and the target engine torque) is obtained by operation based on the amount of accelerator operation of the driver and the vehicle speed. In a flowchart for calculating a motor torque command value in FIG. 5, respective target torques of the first motor-generator 5 and the second motor-generator 6 are obtained by operation based on the target engine operating point.

First, when a program for the control of calculating the target operating point of the engine in FIG. 4 starts (101), the process proceeds to a step (102) for retrieving a detection signal of the accelerator position form the accelerator position detecting unit 19 constituted by an accelerator position sensor, a detection signal of the vehicular speed from the vehicular speed detecting unit 20 constituted by a vehicle speed sensor, a detection signal of the state of charge SOC of the battery 18 from the battery state-of-charge detecting unit 21, that is, various signals are used in the control.

Subsequently, the process proceeds to a step (103) for detecting the target driving force from the map for detecting target driving force illustrated in FIG. 6.

This step (103) is a step for calculating a target driving force corresponding to a vehicle speed and an accelerator position from the map for detecting target driving force illustrated in FIG. 6.

At this time, in the case where “the accelerator position=0”, the target driving force is set to a negative value to obtain a driving force in a decelerating direction equivalent to engine brake in a high vehicle speed range. In a range at low vehicle speed, the target driving force is set to a positive value to allow creep running.

The target driving force, which is calculated in the step (103) for detecting the target driving force from the map for detecting target driving force in FIG. 6, and the vehicle speed are multiplied together. Subsequently, the process proceeds to a step (104) for calculating the target drive power.

This step (104) is a step for multiplying the target driving force, which is calculated in step (103), and the vehicle speed to calculate a target drive power required for driving the vehicle with the target driving force.

Additionally, the process proceeds to a step (105) for calculating the target charging/discharging power from a table for searching target charging/discharging power in FIG. 7.

This step (105) is a step for calculating a target amount of charging and discharging from the table for searching target charging/discharging power disclosed in FIG. 7 so as to control the state of charge SOC of the battery 18 within a range in normal use.

At this time, in step (105), in the case where the state of charge SOC of the battery 18 is low, charging power is increased to prevent excessive discharge of the battery 18. In the case where the state of charge SOC of the battery 18 is high, discharging power is increased to prevent excessive charge.

Further, the process proceeds to a step (106) for calculating the target engine power.

This step (106) is a step for calculating the target engine power that is a power to be output by the internal combustion engine 2 based on the target drive power and the target charging/discharging power.

At this time, the power to be output by the internal combustion engine 2 has a value where a power for charging the battery 18 is added (subtracted in case of discharging) to a power required for driving the vehicle.

Here, this value is set as a negative value at the charging side. Accordingly, the target charging/discharging power is subtracted from the target drive power to calculate the target engine power.

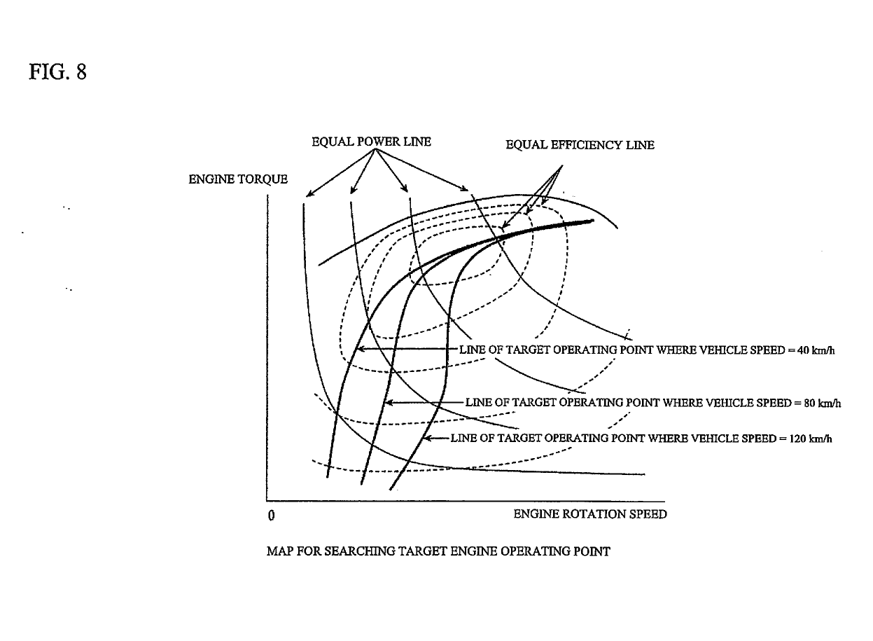

The process proceeds to a step (107) for calculating the target engine operating point from a map for searching target engine operating point in FIG. 8.

This step (107) is a step for calculating the target engine operating point corresponding to the target engine power and the vehicle speed from the map for searching target engine operating point disclosed in FIG. 8.

After the step (107) for calculating the target engine operating point from the map for searching target engine operating point in FIG. 8, the process proceeds to return (108).

The map for searching target engine operating point in FIG. 8 sets each line that connects points set for each power with a high overall efficiency as a line of target operating point. The line of target operating point is set considering an efficiency of the internal combustion engine 2 in addition to an efficiency of a power transmission system constituted by the differential gear mechanism 15 and the first and second motor-generators 5 and 6 on each equal power line.

The line of target operating point is set for each vehicle speed.

At this time, the set value may be obtained by experiment, or may be obtained by calculation based on respective efficiencies of the internal combustion engine 2, the first motor-generator 5, and the second motor-generator 6.

The line of target operating point is set to move to a high rotation side as the vehicle speed becomes higher.

The reason is described as follows.

In the case where the target engine operating point is set to the same engine operating point regardless of the vehicle speed, as illustrated in FIG. 9, the first motor-generator 5 has a positive rotation speed at a low vehicle speed. The first motor-generator 5 functions as a generator while the second motor-generator 6 functions as an electric machine (see point A).

As the vehicle speed becomes higher, the rotation speed of the first motor-generator 5 approaches zero (see point B). Further, in the case where the vehicle speed becomes high, the first motor-generator 5 has a negative rotation speed. In this state, the first motor-generator 5 functions as an electric machine while the second motor-generator 6 functions as a generator (see point C).

In the case where the vehicle speed is low (in the states of points A and B), power circulation does not occur. Accordingly, the target operating point mostly becomes close to the point with high engine efficiency like a line of target operating point where the vehicle speed=40 km/h in FIG. 8.

However, in the case where the vehicle speed becomes high (in the state of point C), the first motor-generator 5 functions as an electric machine while the second motor-generator 6 functions as a generator. Therefore, power circulation occurs. This reduces the efficiency of the power transmission system.

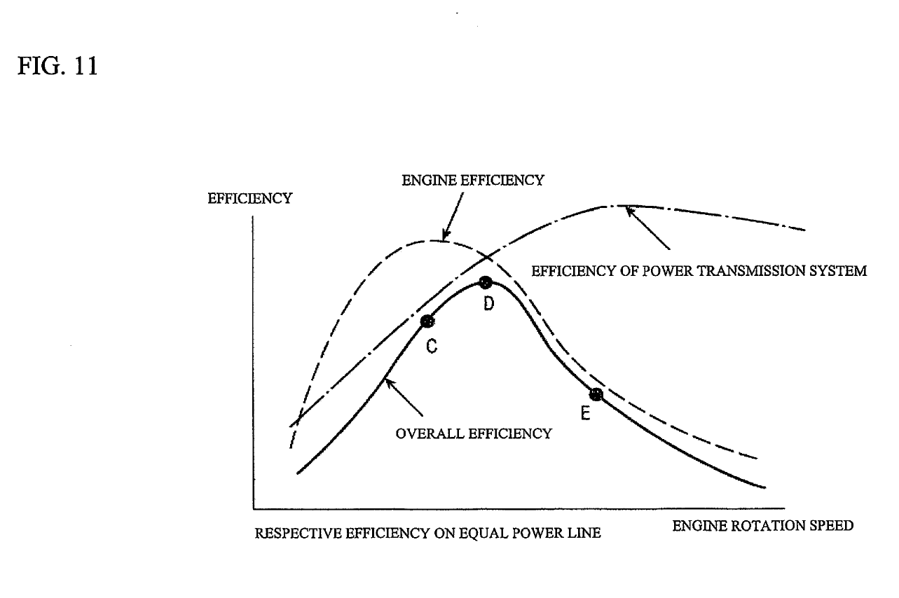

Accordingly, as illustrated at point C in FIG. 11, the reduction in efficiency of the power transmission system causes reduction in overall efficiency even if the efficiency of the internal combustion engine 2 is high.

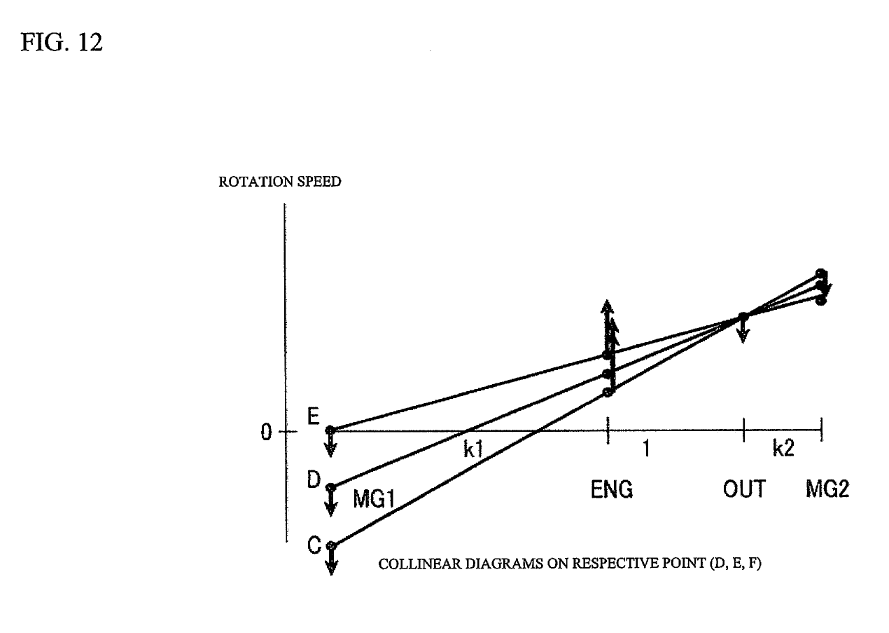

In order not to generate power circulation, the rotation speed of the first motor-generator 5 is simply set equal to or more than zero as illustrated at point E in the collinear diagram of FIG. 12. As a result, the operating point moves to a high rotation speed side of the internal combustion engine 2. As illustrated in point E of FIG. 11, the efficiency of the internal combustion engine 2 is significantly reduced even if the efficiency of the power transmission system becomes high. This reduces overall efficiency.

Accordingly, as illustrated in FIG. 11, a point with high overall efficiency is set to point D between two points. Employing this point as the target operating point allows the most efficient driving.

As described above, FIG. 10 illustrates three operating points of point C, point D, and point E on a map for searching target operating point. It is seen that an operating point with the best overall efficiency moves to a high rotation side compared with the operating point with the best engine efficiency in the case where the vehicle speed becomes high.

Next, a description will be given of an operation of target torques for the first motor-generator 5 and the second motor-generator 6 to obtain charge and discharge amount at the target value for the battery 18 while outputting the target driving force along the flowchart for calculating the motor torque command value of FIG. 5.

First, a program for calculating the motor torque command value in FIG. 5 starts (201). Subsequently, the process proceeds to a step (202) for calculating an MG1 rotation speed Nmg1t of the first motor-generator 5 and an MG2 rotation speed Nmg2t of the second motor-generator 6.

In this step (202), a drive shaft rotation speed No of the planet gear is calculated based on the vehicle speed.

Subsequently, in the case where the engine rotation speed becomes the target engine rotation speed Net, the MG1 rotation speed Nmg1t of the first motor-generator 5 and the MG2 rotation speed Nmg2t of the second motor-generator 6 are calculated with the following formulas.

These formulas are obtained by a relationship with the rotation speed of the planet gear.

[Formula 1]

Nmg1t=(Net−No)*k1+Net (1)

[Formula 2]

Nmg2t=(No−Net)*k2+No (2)

Here, k1 and k2 are values determined by a gear ratio of the planet gear as described below.

Next, the process proceeds to a step (203) for calculating the basic torque Tmg1i of the first motor-generator 5 based on the MG1 rotation speed Nmg1t of the first motor-generator 5 and the MG2 rotation speed Nmg2t of the second motor-generator 6, which are obtained in step (202), a target charging/discharging power Pbatt, and a target engine torque Tet.

In this step (203), the basic torque Tmg1i of the first motor-generator 5 is calculated with the following formula (3).

[Formula 3]

Tmg1i=(Pbatt*60/2π−Nmg2t*Tet/k2)/(Nmg1t+Nmg2t* (1+k1)/k2) (3)

This formula (3) is derived from a simultaneous equation formed by the following formula (4) and formula (5). Formula (4) expresses balance of torque input to the planet gear. Formula (5) expresses that electric power generated or consumed in the first motor-generator 5 and the second motor-generator 6 are equal to input or output power (Pbatt) to the battery 18.

[Formula 4]

Tet+(1+k1)*Tmg1=k2*Tmg2 (4)

[Formula 5]

Nmg1*Tmg1*2π/60+Nmg2*Tmg2*2π/60=Pbatt (5)

After the step (203) for calculating the basic torque Tmg1i of the first motor-generator 5, the process proceeds to a step (204) for calculating the basic torque Tmg2i of the second motor-generator 6 based on the basic torque Tmg1i of the first motor-generator 5 and the target engine torque.

In this step (204), the basic torque Tmg2i of the second motor-generator 6 is calculated with the following formula (6).

[Formula 6]

Tmg2i=(Tet+(1+k1)*Tmg1i)/k2 (6)

This formula (6) is derived from the formula (4).

After the step (204) for calculating the basic torque Tmg2i of the second motor-generator 6, the process proceeds to a step (205) for calculating the respective feedback correction torques Tmg1fb and Tmg2fb of the first and second motor-generators 5 and 6.

In this step (205), to make the engine rotation speed close to the target, a deviation of the engine rotation speed with respect to the target value is multiplied by a predetermined feedback gain, which is preliminarily set, to calculate the respective feedback correction torques Tmg1fb and Tmg2fb of the first and second motor-generators 5 and 6.

The feedback gain used here is set to have the following rate.

[Formula 7]

MG2 feedback gain=k1/(1+k2)*MG1 feedback gain (7)

This provides a ratio of the feedback correction torques as follows.

[Formula 8]

Tmg2fb=(k1/(1+k2))*Tmg1fb (8)

This prevents variation in torque of the drive shaft even if the engine torque varies.

Here, a description will be given of a reason that the torque of the drive shaft does not vary.

For comparison, assume that a case where only a feedback of the first motor-generator 5 is performed to make the engine rotation speed close to the target value.

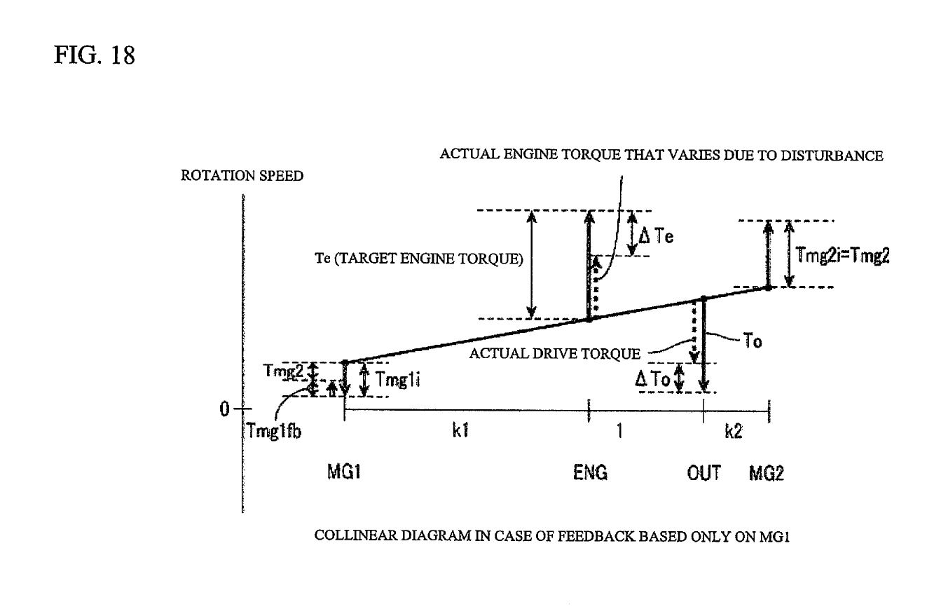

FIG. 18 illustrates a collinear diagram in this case.

The feedback correction torque Tmg1fb of the MG1 torque is calculated as follows in the case where the engine torque varies by ΔTe with respect to the target torque based on the torque balance equation focusing on a variation amount of the torque.

[Formula 9]

Tmg1fb=−ΔTe/(1+k1) (9)

However, ΔTe is unknown. The feedback correction torque Tmg1fb of the MG1 torque is actually calculated based on a feedback of the rotation speed as described above.

A variation amount ΔTo of the torque of the drive shaft becomes the following value.

[Formula 10]

ΔTo=−ΔTe*k1/(1+k1) (10)

This shows that variation in engine torque varies the torque of the drive shaft.

In contrast, a description will be given of a case where a feedback correction of the second motor-generator 6 is also performed in addition to the feedback correction of the first motor-generator 5 like the present invention.

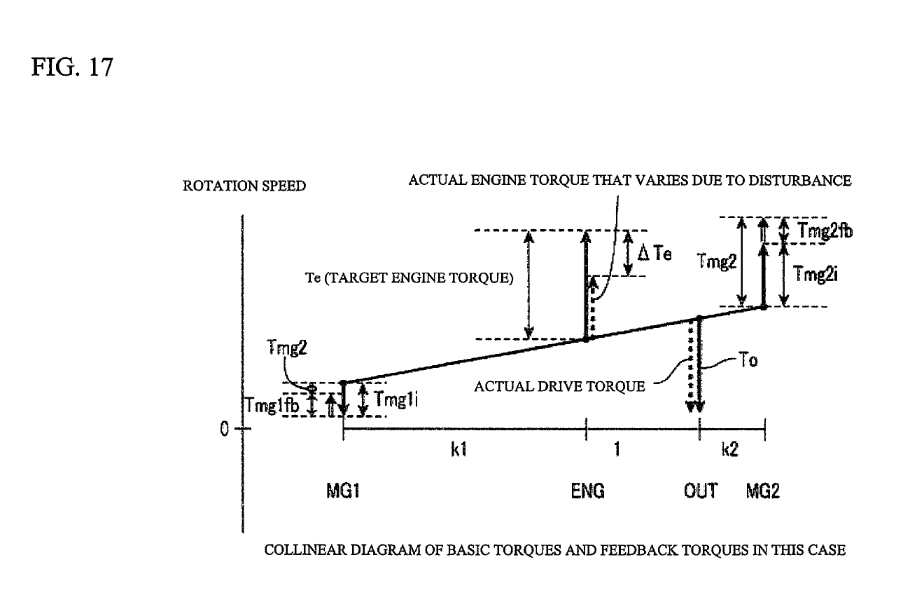

FIG. 17 illustrates a collinear diagram in this case.

A torque balance equation is as follows focusing on a variation amount of torque in the case where the drive shaft 8 is a supporting point.

[Formula 11]

k2*Tmg2fb=ΔTe+(1+k1)*Tmg1fb (11)

The variation amount of the torque of the drive shaft is equal to a sum of respective variation amounts for each torque. Thus, the following formula is satisfied.

[Formula 12]

ΔTo=Tmg1fb+ΔTe+Tmg2fb (12)

In the case where there is no variation amount of the torque of the drive shaft, ΔTo=0 is satisfied. Thus, the following formula is satisfied.

[Formula 13]

Tmg1fb+ΔTe+Tmg2fb=0 (13)

Solution of formula (11) and formula (13) results in formula (8) described above. This shows that if this relationship is satisfied, the torque of the drive shaft does not vary even if the engine torque varies.

After the step (205) for calculating the respective feedback correction torques Tmg1fb and Tmg2fb of the first and second motor-generators 5 and 6, the process proceeds to a step (206) for calculating the control torque command value Tmg1 of the first and second motor-generators 5 and 6.

In this step (206), respective feedback correction torques are added to respective basic torques to calculate the control torque command value Tmg1 of the first and second motor-generators 5 and 6.

Subsequently, controlling the first and second motor-generators 5 and 6 in accordance with the control torque command value Tmg1 allows charging and discharging the battery 18 corresponding to the value close to the target value while outputting the target driving force even if the engine torque varies due to disturbance.

After the step (206) for calculating the control torque command value Tmg1 of the first and second motor-generators 5 and 6, the process proceeds to return (207).

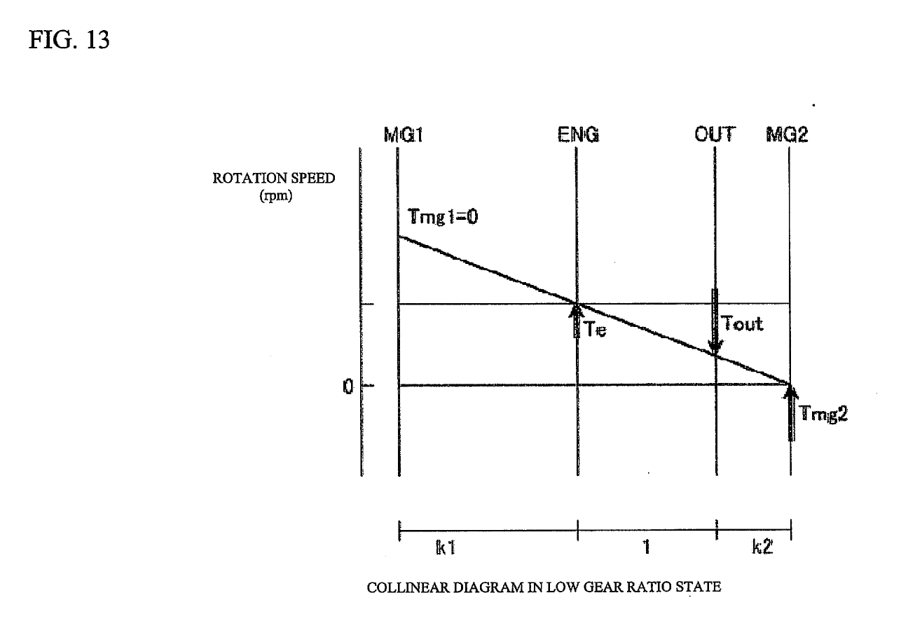

FIGS. 13 to 16 each illustrate a collinear diagram in a typical operating state.

Here, the values k1 and k2 determined by the gear ratio of the planet gear are defined as follows.

k1=ZR1/ZS1

k2=ZS2/ZR2

ZS1: the number of teeth of a PG1 sun gear

ZR1: the number of teeth of a PG1 ring gear

ZS2: the number of teeth of a PG2 sun gear

ZR2: the number of teeth of a PG2 ring gear

Next, respective operating states will be described by referring to the collinear diagrams.

The rotation speed is defined to have a positive direction that is the rotation direction of the internal combustion engine 2. The torque input/output to each shaft is defined to have a positive direction that is a direction to input a torque in the same direction as the torque of the internal combustion engine 2.

Therefore, in the case where the torque of the drive shaft is positive, a torque to drive the vehicle backward is output (for deceleration during forward movement or driving during backward movement). In the case where the torque of the drive shaft is negative, a torque to drive the vehicle forward is output (for driving during forward movement or deceleration during backward movement).

In the case where electric generation and power running (transmission of power to the wheel (the drive wheel) for acceleration or for maintaining the balance speed on a rising slope) is performed by the motor, loss due to heat generation in the inverter and the motor occurs. Accordingly, the efficiency of conversion between the electric energy and mechanical energy is not 100%. However, for ease of explanation, assume that no loss occurs in this description.

In the case where actual loss is considered, the control is performed to simply generate extra electric energy corresponding to lost energy due to the loss.

### (1) LOW Gear Ratio State

In this state, running is performed by the internal combustion engine and the rotation speed of the second motor-generator 6 is zero.

A collinear diagram in this state is illustrated in FIG. 13.

Since the rotation speed of the second motor-generator 6 is zero, electric power is not consumed.

Accordingly, in the case where charging and discharging the storage battery are not performed, electric generation of the first motor-generator 5 is not necessary. The torque command value Tmg1 of the first motor-generator 5 becomes zero.

A ratio between the engine rotation speed and the drive shaft rotation speed becomes (1+k2)/k2.

### (2) Intermediate Gear Ratio State

In this state, running is performed by the internal combustion engine 2 and the respective rotation speeds of the first motor-generator 5 and the second motor-generator 6 are positive.

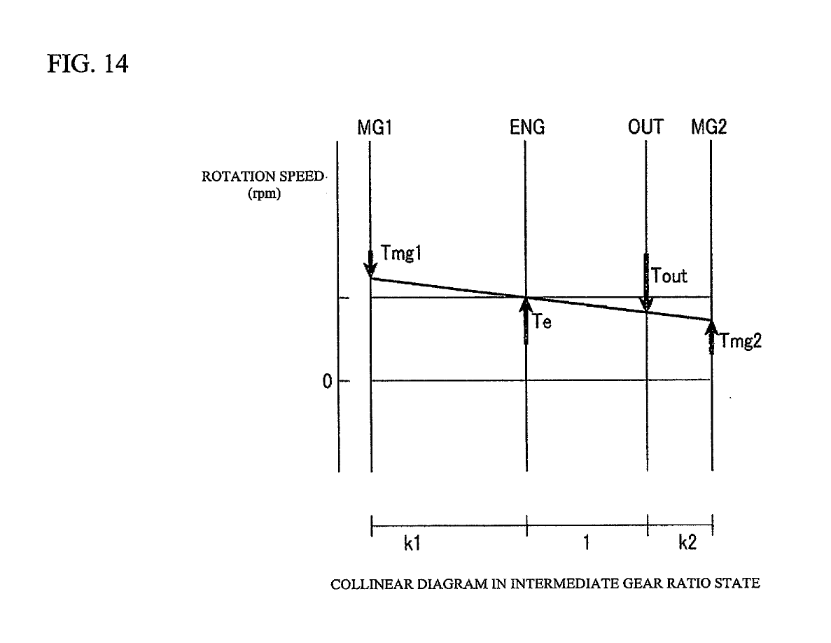

A collinear diagram in this state is illustrated in FIG. 14.

In this case, in the case where charging and discharging the storage battery are not performed, the first motor-generator 5 regenerates electric power. This regenerative electric power allows power running of the second motor-generator 6.

### (3) HIGH Gear Ratio State

In this state, running is performed by the internal combustion engine 2 and the rotation speed of the first motor-generator 5 is zero.

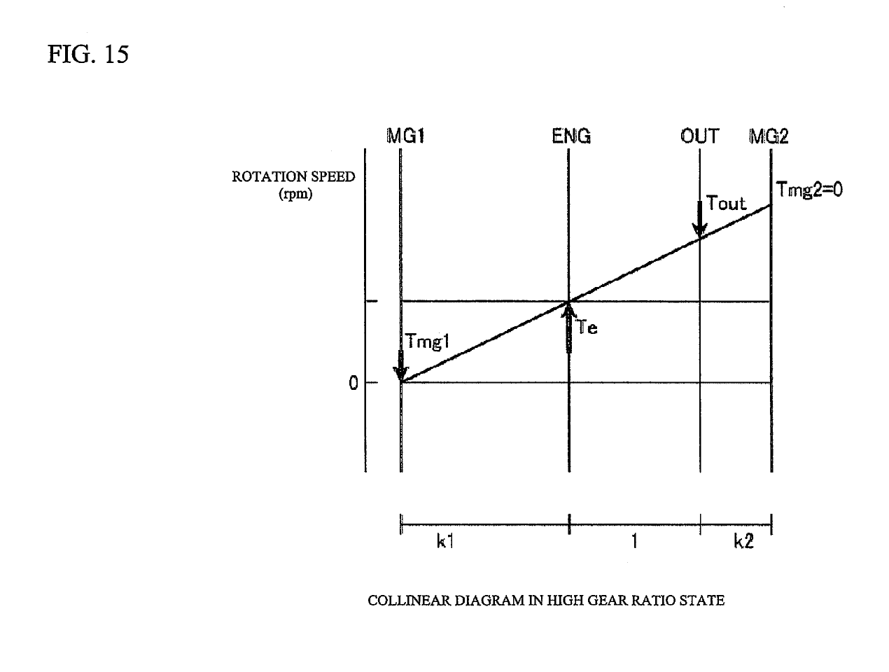

A collinear diagram in this state is illustrated in FIG. 15.

Since the rotation speed of the first motor-generator 5 is zero, regeneration is not performed.

Accordingly, in the case where charging and discharging the storage battery is not performed, power running or regeneration of the second motor-generator 6 is not performed. The torque command value Tmg2 of the second motor-generator 6 becomes zero.

A ratio between the engine rotation speed and the drive shaft rotation speed becomes k1/(1+k1).

(4) State where Power Circulation Occurs

In a state where the vehicle speed is higher than that of the HIGH gear ratio state, the first motor-generator 5 rotate inversely

In this state, the first motor-generator 5 performs power running and consumes electric power.

Accordingly, in the case where charging and discharging the storage battery are not performed, the second motor-generator 6 (5) performs regeneration so as to generate electric power.

That is, this embodiment of the present invention has a main configuration as follows. The respective feedback torques for rotation of the first motor-generator 5 and the second motor-generator 6 to have the engine rotation speed close to the target rotation are calculated based on the deviation between the engine rotation speed and the target engine rotation speed. The ratio between the respective feedback torques of the first motor-generator 5 and the second motor-generator 6 is set to a predetermined ratio based on the gear ratio of the planetary gear without any influence on the torque of the drive shaft.

This embodiment of the present invention controls to satisfy MG2 feedback torque=k1/(1+k2)*MG1 feedback torque.

The feedback gain is set to satisfy MG2 feedback gain=k1/(1+k2)*MG1 feedback gain.

This provides an advantageous effect that prevents variation in driving force even if the engine output torque varies with respect to the target torque.

### DESCRIPTION OF REFERENCE SIGNS

1 drive control apparatus for hybrid vehicle
2 internal combustion engine (also described as “E/G” or “ENG”)
3 output shaft
4 one-way clutch
5 first motor-generator (also referred to as “MG1” or “first electric motor”)
6 second motor-generator (also referred to as “MG2” or “second electric motor”)
7 drive wheel
8 drive shaft
9 first planetary gear (also referred to as “PG1”)
10 second planetary gear (also referred to as “PG2”)
11 air-amount adjusting unit
12 fuel supply unit
13 ignition unit
14 output gear
15 differential gear mechanism
16 first inverter
17 second inverter
18 battery
19 accelerator position detecting unit
20 vehicular speed detecting unit
21 battery state-of-charge detecting unit
22 target drive power setting unit
23 target charging/discharging power setting unit
24 target engine power calculation unit
25 target engine operating point setting unit
26 motor torque command value operation unit
27 drive controller
28 engine rotation speed detecting unit
29 target driving force calculator
30 target drive power calculator
31 to 37 first to seventh calculators

1. A drive control apparatus for a hybrid vehicle, comprising:
an internal combustion engine with an output shaft;
a drive shaft coupled to a drive wheel;
first and second motor-generators;
a differential gear mechanism that includes respective four rotational elements coupled to the plurality of motor-generators, the drive shaft, and the internal combustion engine;
an accelerator position detecting unit configured to detect an accelerator position;
a vehicular speed detecting unit configured to detect a vehicular speed;
a battery state-of-charge detecting unit configured to detect a state of charge of battery;
a target drive power setting unit configured to set a target drive power based on an accelerator position detected by the accelerator position detecting unit and a vehicular speed detected by the vehicular speed detecting unit;
a target charging/discharging power setting unit configured to set a target charging/discharging power based on at least a state of charge of battery detected by the battery state-of-charge detecting unit;
a target engine power calculation unit configured to calculate a target engine power using the target drive power setting unit and the target charging/discharging power setting unit;
a target engine operating point setting unit configured to set a target engine operating point based on the target engine power and an overall efficiency of a system; and
a motor torque command value operation unit configured to set respective torque command values of the plurality of motor-generators,
wherein the motor torque command value operation unit is configured to:
calculate respective torque command values of the plurality of motor-generators using a torque balance equation and a power balance equation, the torque balance equation including a target engine torque obtained from the target engine operating point, the power balance equation including the target charging/discharging power; and
allow respective feedback corrections of the torque command values for the plurality of motor-generators such that an actual engine rotation speed converges to a target engine rotation speed obtained from the target engine operating point in the drive control apparatus for the hybrid vehicle, and
wherein the motor torque command value operation unit is configured to:
calculate a torque correction value of the first motor-generator and a torque correction value of the second motor-generator among the plurality of motor-generators based on a deviation between the actual engine rotation speed and the target engine rotation speed when the feedback correction is performed; and
set a ratio between the torque correction value of the first motor-generator and the torque correction value of the second motor-generator to a predetermined ratio based on a lever ratio of the drive control apparatus for the hybrid vehicle.

2. The drive control apparatus for the hybrid vehicle according to claim 1,
wherein the four rotational elements of the differential gear mechanism are arranged in an order corresponding to a rotational element coupled to the first motor-generator, a rotational element coupled to the internal combustion engine, a rotational element coupled to the drive shaft, and a rotational element coupled to the second motor-generator in a collinear diagram, and respective mutual lever ratios among the elements are set as k1:1: k2 in a same order, and
the torque correction value of the first motor-generator and the torque correction value of the second motor-generator are set to maintain a relationship where a value of the torque correction value of the first motor-generator multiplied by k1 is equal to a value of the second motor-generator multiplied by 1+k2.

3. The drive control apparatus for the hybrid vehicle according to claim 1,
wherein the four rotational elements of the differential gear mechanism are arranged in an order corresponding to a rotational element coupled to the first motor-generator, a rotational element coupled to the internal combustion engine, a rotational element coupled to the drive shaft, and a rotational element coupled to the second motor-generator in a collinear diagram, and respective mutual lever ratios among the elements are set as k1:1:k2 in a same order, and
a feedback gain is set such that the torque correction value of the first motor-generator and the torque correction value of the second motor-generator have a relationship where a value of the torque correction value of the first motor-generator multiplied by k1 is equal to a value of the second motor-generator multiplied by 1+k2.
